(19) United States
(12) Patent Application Publication
(10) Pub. No.: US 2014/0007451 A1
(43) Pub. Date: Jan. 9, 2014

(54) Hay Storage System

(71) Applicant: Owen Jackson Brown, JR., Pittsfield, IL (US)

(72) Inventor: Owen Jackson Brown, JR., Pittsfield, IL (US)

(21) Appl. No.: 13/937,607

(22) Filed: Jul. 9, 2013

Related U.S. Application Data
(60) Provisional application No. 61/669,422, filed on Jul. 9, 2012.

(51) Int. Cl. A01F 25/00; A01F 25/14

(52) U.S. Cl. CPC A01F 25/00; A01F 25/14
USPC 34/265; 34/218; 34/557; 34/565; 34/428; 34/443

(57) ABSTRACT

A device and method for storing, curing, drying hay and other fibrous plant materials which includes a flexible water impermeable bag, as injection means at one end and an adjustable vent at the opposite end, and preferably spacer means between stacks of baled materials. The bales are progressively loaded at one end as the bag is unrolled and extended progressively laterally for additional bales. After loading, the gas injection and vent means are connected at ends of the bag and are adjusted to generate a back pressure within the bag to partially inflate it. The flowrate of gas or air is adjusted to maintain the temperature within the bales within an optimal range, preferably between ambient temperature and 120 degrees Fahrenheit enabling beneficial curing until sufficient moisture has been removed to prevent mold growth.

### CROSS REFERENCE TO RELATED APPLICATIONS

This application claims the benefit of provisional patent application Ser. No. 61,669,422, filed 9 Jul., 2012.

### STATEMENT REGARDING FEDERALLY FUNDED RESEARCH

Not applicable

### FIELD OF INVENTION

The present invention relates to an apparatus and method for curing, drying and storing stacks of hay bales and other fibrous crops, such as grass, alfalfa, cotton and other fibrous materials which may be compressed and stacked in bales.

### BACKGROUND OF THE INVENTION

Historically a typical agricultural process has been to cut forage, allow some degree of drying to occur, rake the fibrous material into windrows for further drying, then collect and store the forage at a desirable moisture content. Handling and storage of the cut forage was improved by baling. Early and current bales are typically square or rectangular, in the range of 20 to 100 pounds each. More modern bales are large units (from several hundred to a thousand pounds) of tightly bound and compressed forage. Also, recent technology has enabled the grouping of small square or rectangular bales into packages for ease of handling, such as with the Bale Bandit (reg. TM of GFC, Inc.) Accompanying this shift has been a shift in storage from piles of smaller bales, often stored indoors or covered outdoors, to outdoor storage of individual large bales or rows of large bales. One primary problem with baled fibrous materials is their propensity to rot, thermally decompose, burn, caramelize or develop mold if not properly dried, stored and preserved. All these processes reduce the nutrient, caloric and saleable value of the baled crop. More recently, the large bales or bundles of small bales have been covered in tight plastic sheeting to protect them from rain and snow and reduce their exposure to oxygen. One approach is to use a large plastic stretch wrap to surround the outer circumference of the large round bale, leaving the flat ends exposed. Another is to use tight overlapping wraps of plastic sheeting. Some examples are the disclosures of Anderson in U.S. Pat. No. 4,793,124 and Reeves in U.S. Pat. No 5,596,864. All these methods still result in environmental degradation of the baled crops due to lack of adequate ventilation, moisture removal and bale temperature control.

U.S. Application 20050210699 dated Sep. 29, 2005 from Phillipe describes a forage bale dryer comprising a bale support platform between a lower and an upper plenum chamber, and the upper plenum chamber is spaced from the support platform to define an accessible stacking area for disposing, one or more layers of forage bales onto the support platform. An air circulating passage is connected to the plenum chambers to direct a drying air flow there across. A sheet of flexible film material is disposed about the stack of bales and between the plenum chambers, whereby upon the application of a drying air flow, a negative pressure causes the flexible film material to collapse against the circumferential side surface of the stack of bales, and the drying air flow is confined through the stack. The drying, air flow is also reversible by proper synchronization of valve plates in the air circulating conduits. This system is not cost effective to dry and subsequently store large volumes of ha bales, typically harvested by most farms. The system requires inserting bales, drying the bales, then moving the bales to storage in order to make room for more bales to dry, adding to the labor costs for operation. Also, the tight connection between the outer plastic sheet material and the outer surface of the bales can, without adequate heating means or prompt removal, lead to moisture condensation collecting between the two surfaces, leading to damaging mold growth on the outer surfaces of the bales. The system requires the use of heated air, adding to the overall equipment and utility cost for operation. The bidirectional means require the use of costly ducting and valves. The system does not provide means to maximize curing of bales.

U.S. Pat. No. 4,846,890 to Macfarlane discloses a method of preserving hay and silage. The method comprises the utilization of a composition for coating the material to form a water-repellent protective coating including a preserving agent, having substantial antimicrobial activity and/or an adhesive farming constituent. This method requires the use of costly chemicals that may have detrimental effects on the environment, and/or on the personnel applying them or on the animals subsequently ingesting the hay comingled with these chemical coatings. Furthermore, the method does not disclose how to ensure every surface of each hay strand is to be coated, without substantial over-application and wastage of the coating materials. Also, the method does nothing to address deleterious moisture levels deep within a typical hay bale, as the applications were only on 4″ thick test hales. The time, labor and space required to coat bales and set them apart for drying prior to stacking would also substantially add to the cost of this method.

U.S. Pat. Nos. 5,078,059 and 5,101,719 to Recker are directed to hay bale ventilators which are mounted on a plunger of a hay baler. Specifically, the ventilator includes a pointed member extending from the plunger face to form a hole or passageway through consecutively formed segments of has in the baler. The pointed member, however, is solid in nature and is designed to push or punch out a hole in the segment of hay. Such pressure can damage or destablize the resulting hay bale due to the disruption of the compacted hay, and leaves the damaged hay in the hole, effectively sealing off the rest of the hale from the drying effects of the hole.

U.S. Pat. No. 5.540,143 to Stromer discloses a hay compressor that includes a packer mechanism which operates to retrieve and compress individual capsules of has and a plunger or piston that compresses the individual precompressed capsules into a large bale while simultaneously cutting and removing portions of the capsules. This method results in wasted hay, in the form of cut ejected plugs. It also does not address the problem of moisture from the environment entering the cut holes leading to rot from within. It also has a negative impact of the structural integrity of the bales, preventing its use on large volumes of stacked hay bales typically harvested and stored by commercial farms. It is also not easily adaptable to typical hay baling equipment, requiring the cutting/punching mechanisms to be periodically removed, sharpened and maintained.

U.S. Pat. No. 4,640,021 to Gullickson is directed to an apparatus for drying a stack of hay hales which includes a movable dryer placed against a first end of the stack and an air and moisture impervious flexible sheet for covering the dryer and a top and sides of the stack. An air fan coupled to the dryer is operable to draw air through the stack from an open thereof into the dryer and to discharge the air from the dryer to atmosphere. This system requires an airtight film, that when in tight contact with the stack of bales results in pockets of trapped condensed moisture which will cause the outer bales to develop mold. The bottom of the bales are in contact with the around and due moisture intrusion during rainy periods and due to no air circulation, this bottom section of the bales will develop mold and rot. Because of the requirement to draw all the air through the stack of bales, this apparatus is not suitable for long stacks or large volumes of bales typically generated by typical commercial hay producers. This apparatus and the abovementioned prior art does not address the critical heat cycle that each bale undergoes. Even if the hale is dried down to 12% moisture, it will go through its heat cycle 7-28 days after baling. There are significant nutritional advantages of giving the bales ventilation during this heat cycle.

The hay storage system disclosed as the subject matter of this patent application provides this ventilation during that critical heat cycles encountered by baled crop materials as they cure and dry.

U.S. Pat. No. 6,070400 to Peeters is directed to forage wrapping device and method which tightly wraps large round bales of hay with plastic sheets to cover them from rain. This and other similar methods of applying tightly adhering films do not address the moisture trapped within the center of the bales. If used on fresh cut bales, the internal moisture migrates to the exterior round surfaces of the bales, where it subsequently condenses on the inside surface of the plastic sheet, particularly in the cool of the evenings, leading to mold growth on the outer surfaces of the bale. The system only works on large round bales, not square bales or stacks of square bales, nor on large quantities of stacked square bales. This method and all others that tightly bind the watertight outer film to the bale or stacks of bales require the exclusion or the minimization of intrusion of oxygen into the stack, or else mold will result. These inventions also do not address the issue of controlling the bales heat cycle during critical curing and drying.

When forage is cut it usually has a moisture content of 70 to 80%. Initial moisture loss occurs from the leaves through the stomates. The plant's natural respiration rate is highest when the plant is first cut and gradually declines until plant moisture has fallen below 40-60%. The stomates then close and plant respiration has stopped. Then the drying occurs from the leaf surface and the plant stem.

From the initial cutting, of the crop to its final drying the plant undergoes a wide range of moisture content. The predominate bacteria and yeast populations present on the standing crop, that are beneficial to curing the hay, are no longer viable as the moisture content drops below their range needed for sustenance. The new species that start to multiply are alternate bacteria, some yeasts, and an increased presence of fungi. These organisms feed off sugars and organic acids exudated from the plant during, the drying process. The faster the crop dries down at this stage, the less dry matter losses occur in the crop from these organisms. Both plant respiration and fungi/bacteria growth cause an increase in plant temperature. The moisture gradient and resultant hay temperatures observed are summarized in Table 1.

TABLE 1

| Description | Moisture % | Hay Temp ° F. |
|---|---|---|
| Forage is mowed | 70% to 80% | |
| Plant respiration | from peak down | 70-110 |
| | to 40% | |
| Fungi and bacteria | | 70-150 |
| Exothermic chemical reactions | | 175-527 |

When bay is baled, the crop is compacted and less ventilated than when it is in the windrow. With the lower moisture levels and higher temperatures associated with baling, a new group of microbes start to multiply. The higher the moisture content of the hay baled, the more microbes will grow, and the more heat generated by the bale.

If moisture content of baled hay is too high, then hay temperatures can rise into ranges that cause significant nutrient damage to the bale, kill the beneficial microbes, and even cause spontaneous combustion due to the accelerated exothermic chemical reactions. See Table 2 for a description of optimal temperature storage ranges.

TABLE 2

| Description | Hay Temp ° F. |
|---|---|
| Protein breakdown & damaged | >120 |
| nutrients | |
| Browning (carmelization) begins at | 140 |
| Preferred Safe Hay Temp - Range | <120 |
| Monitor Closely - Range | 120 < t < 140 |
| Spontaneously Combust - Range | 140 < t < 180 |

It is during this heat cycle that the bale is expelling both heat and moisture until the moisture content of the bale drops low enough to cease most microbial activity and to cease chemical reactions that take place. In addition the bale will equalize its moisture content with the relative humidity of its storage location.

It is important therefore that the surrounding environment of the bale facilitates proper ventilation to encourage both drying and reduced bale temperature until the bale fully goes through its heat cycle. As it has been found that increased bale ventilation during this heat cycle reduces hay temperature, reduces heat damage, and increases nutritional value and sugar content of the stored crop.

One factor the prior art failed to address, and what was an unexpected resultant benefit of the subject invention, was that by regulating and varying either automatically or manually the air flow and exhaust rate through or around the baled materials at these different stages, one can optimize the beneficial rate and degree of forage curing, while also subsequently minimizing, the detrimental growth of mold, thermal degradation and loss of nutrient value in the latter stages of forage drying and storage.

What is needed is a low cost means to cure, store, dry and preserve large quantities of fibrous moist agricultural products and plant materials of all types, shapes and sizes, whether loose or compressed into bales. What is needed is a system to store, dry and preserve such materials without the need for multiple handling of the materials between each step of curing, storing, drying and preserving. What is needed is a means to store quantities of baled materials substantially outdoors that will prevent formation of mold on the outer surfaces as well as the interior of such baled materials. What is needed is a means to optimize conditions for beneficial curing and fermenting of hay, while minimizing detrimental fungus growth, thermal degradation and resultant loss of nutrients and reduction in market value. What is further needed is a means to safely and economically apply preserving or nutritional-enhancing materials to such quantities of forage materials as they are being stored, dried and/or preserved.

### BRIEF SUMMARY OF THE INVENTION

According to the invention is provided an apparatus and method for storing and drying bales and compressed bundles of grassy materials, including bales of fibrous materials such as straw, cotton or hay. The invention includes a water impermeable flexible container around the materials, a variable gas injection means at one end and an adjustable vent means at the opposing end, one or both adjusted to maintain a positive pressure in the flexible container. The gas flow through and around the materials is adjusted to maximize the curing of the materials and to prevent undesired heat buildup or mold growth.

The system allows a portable, low cost means to store, dry and preserve large quantities of bales and bundles to prevent degradation of such materials. In this disclosure, the phrases bales and bundles are to be considered interchangeable, and can pertain to all types of baled hay, such as but not limited to round bales, large rectangular bales, small square bales or bundled small square bales. In this invention, the phrase hay is defined to include all types of forage, fodder and fibrous materials, including but not limited to straw, cotton, silage, alfalfa or hay.

In an alternative aspect of the invention there is provided a method of drying a stack of hay bales which includes placing air-directing spacers and an optional plenum chamber between the bales or stacks of bales to enhance air movement through and around the bales.

The method may also include an auxiliary injection an heating means, such as a dryer, or a microwave emitter means with a microwave containment means applied to the container walls, to increase the drying rate of the crop materials. Preferably a temperature sensor means, such as a thermocouple, is inserted in or near one or more sections of the crop materials, and/or a moisture sensing means such as a humidistat placed in the exit stream near the exhaust vent, to monitor moisture and or temperature levels and provide a signal means to either an actuator valve on the vent or a valve or motor control drive on the gas injection or both, to adjust the air flows and pressures to optimize curing and subsequent drying rates, and minimize unnecessary air injection once the crop has dried sufficiently for long term storage.

The invention will be now further described, reference being as to the accompanying drawings.

### BRIEF DESCRIPTION OF THE DRAWINGS

In drawings of various embodiments of the invention.

FIG. 1 is a side and perspective view of the apparatus in place around a stack of square hay bales;

FIG. 2 is a side and perspective view of the apparatus in place around large round hay bales;

FIG. 3 is a side and perspective elevation view an embodiment of the apparatus including an optional dryer means and the additional of hollow air sleeves placed beneath each stack or between layer of bales.

FIG. 4 is a side and perspective elevation view of an embodiment of the apparatus including an optional plenum and vented pallet ducts between two layers of bales or stacks of bales, and an optional microwave emitter means and optional solar energy absorbing means on or within the container walls and the addition of hollow air sleeves placed beneath the lower stack or layer of bales.

FIG. 5 is a side and perspective elevation detailed view of an embodiment of the apparatus including an optional plenum and vented pallet ducts between an upper and lower layer of bales or stacks of bales, and the addition of hollow sleeves placed beneath the lower stack or layer of bales, showing the general detailed flowpath of the air directed into the container chamber.

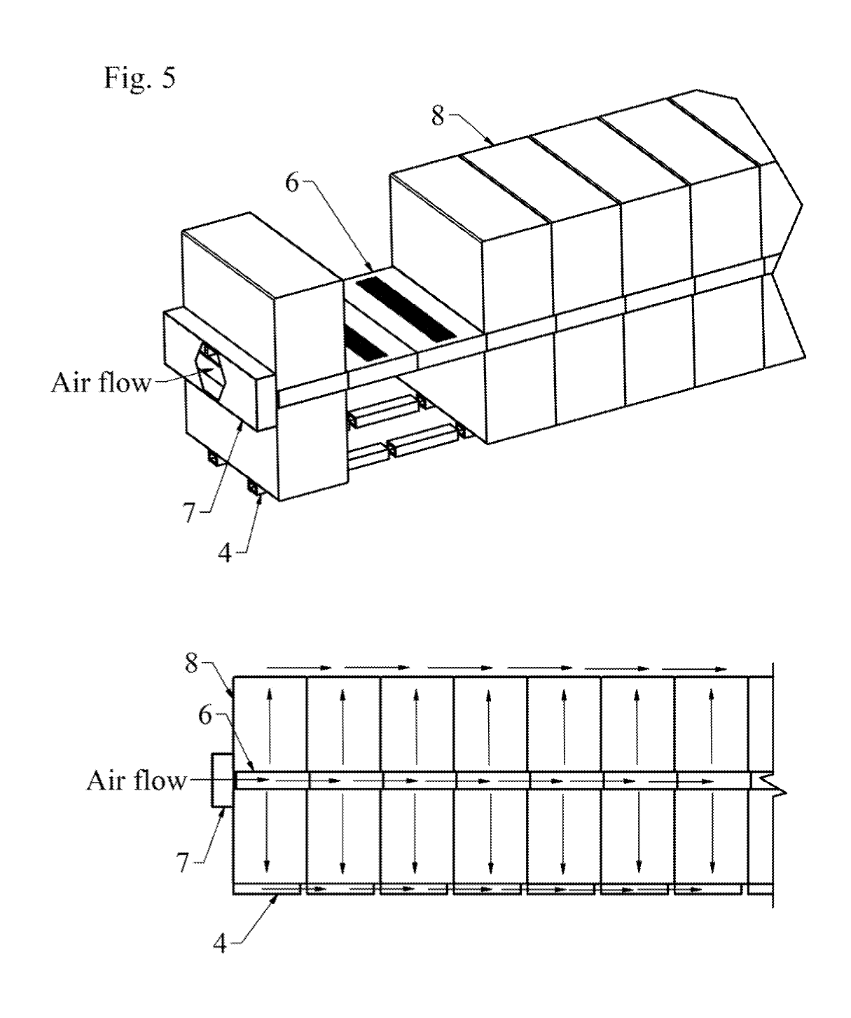

### DETAILED DESCRIPTION OF THE INVENTION

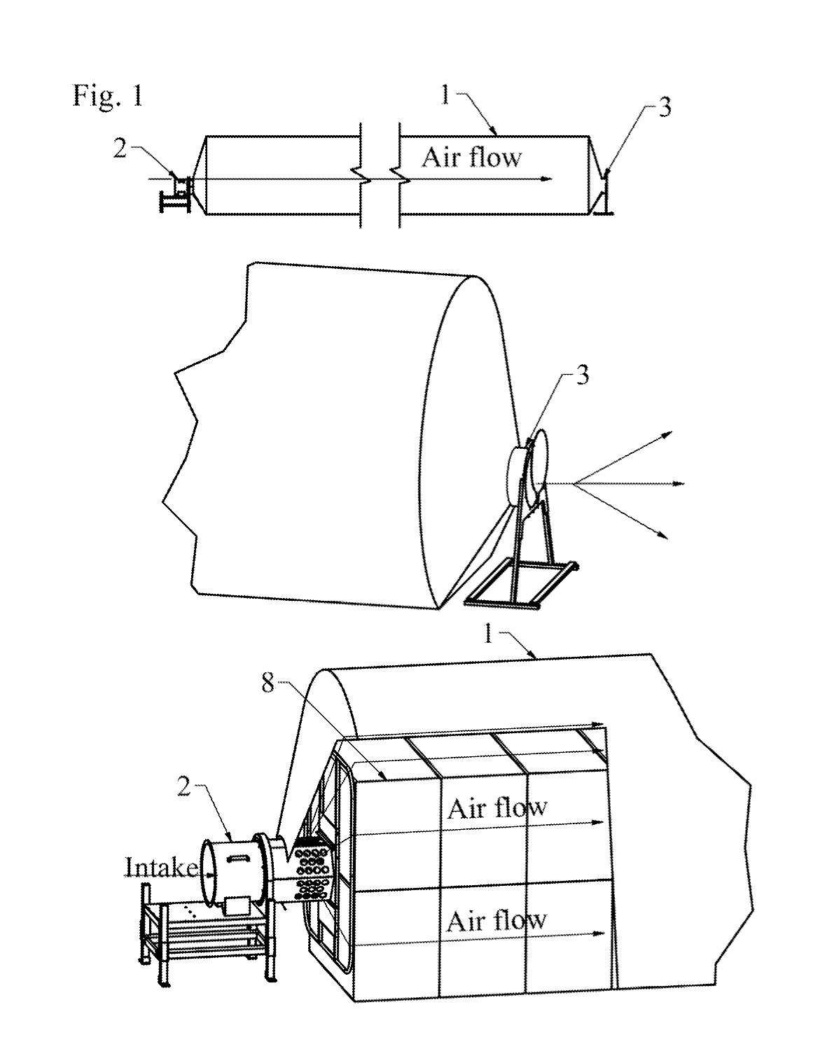

See FIG. 1. In one embodiment, a substantially waterproof container bag 1 typically fabricated from any group of extruded or cast plastic or water-resistant or coated paper or reinforced films, and of various different diameters dependent upon the size of bale or configuration, and cross section of bundles to be stored, is positioned in a generally horizontal position, typically rolled up to a substantially compact configuration, with total length of a few feet extending outward, however the bag may be totally or partially unrolled. The preferred method is to only unroll and extend sufficient length of bags to extend over the next hale or group of bundles in a single load. Finished unrolled lengths of these bags can vary from a few feet to up to several hundred feet long. This bag 1 is used to create a controlled environment for thy hay curing, drying and storage.

A fan, compressor, gas supply or other mechanical air injection means and support structure 2 is preferably secured to one end of bag 1, to provide an anchor point for the bag. The end of the bag not attached to the fan is pulled to begin expanding the length of the unrolled hag. The bundles are loaded into the bag 1 either manually or with any combination of forklifts or other material handling equipment. With each successive load or bale, the hag is preferably pulled and unrolled and length increased to receive the next load of bales or bundles. When bag 1 is sufficiently filled with bales or bundles an Exhaust Valve 3 is secured to other end of bag 1. Air injection means 2 is turned on, inflating the bag 1 to create an airflow on top and around sides of hay bundles. The Exhaust Valve 3 is adjusted to control and balance the airflow with the speed and volume of the fan 2 to keep bag 1 inflated while allowing sufficient airflow exhaust to carry out moisture emanating from the bundles and maintain temperatures of the crop within optimal range. Preferably one or more temperature probes between or within one or more bales or piles of stored crop provide signal means to either the operator or the gas injection or vent means to enable either manual or automatic adjustment of the gas flow through the crop and the container bag.

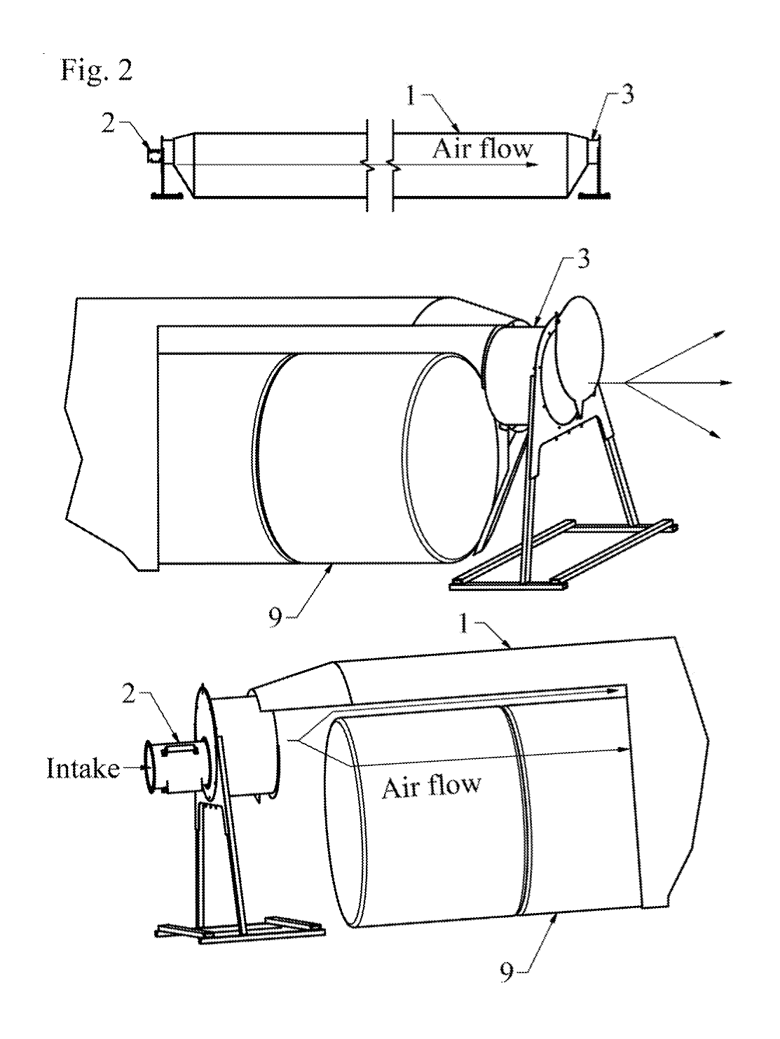

See FIG. 2. In this embodiment the locations of the air injection means or fan 2 and vent means comprising an adjustable draw string or exhaust valve 3 are located substantially in the upper half of the bag 1 cross section elevation, to primarily provide airflow over the top and side areas of the bag, as disclosed for round bales. However, the fan and exhaust valve may be positioned at any elevation relative to the cross section of the bag.

The disclosed system works for all types of baled grassy or fibrous materials, such as but not limited to: round bales (see FIG. 2), large rectangular bales, small square bales, or bundled small square bales.

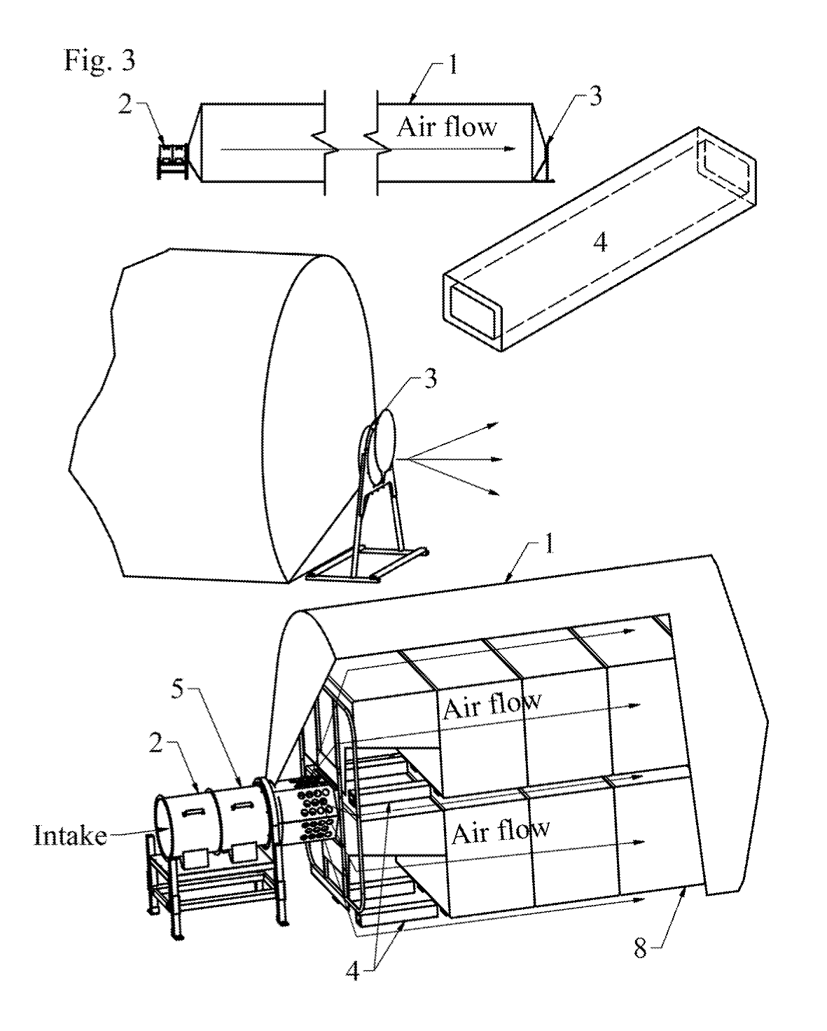

(See drawing: FIG. 3) This embodiment substantially utilizes the same bag, art injection means and valve as disclosed in the first embodiment. The bundles are loaded into the bag 1 either manually or with any combination of forklifts or other material handling equipment. During loading sleeves 4 are placed underneath and between layers of bales or stacks of bales, creating air passages under and between such bales. These sleeves may be comprised of any material of sufficient strength and stiffness to support the weight of the bundles or bales above them, typically fabricated from wood, metal or preferably plastic. Their cross section or shape may be of any configuration of sufficient area to enable gaps between the bundles or bales, and to allow air flow through or between the sleeves.

In FIG. 3 the preferred embodiment is shown, indicating a substantially rectangular hollow shape, preferably of sufficient cross section to enable forks or other lift means to be inserted thereinto, to enable the sleeves to be used as a lift base for the bundles or bales during loading.

When bag 1 is partially or sufficiently full of materials a fan 2 is secured to one end of bag 1 an Exhaust Valve 3 is secured to other end of bag 1. Fan 2 is turned on, inflating the bag 1 to create an airflow on top, bottom and sides of hay, and also partially through and between the sleeves and the air spaces created between the bundles by the sleeves. The Exhaust Valve 3 is adjusted to control and balance the airflow with the speed and volume of the fan 2 to keep bag 1 inflated while allowing sufficient airflow exhaust to carry out moisture and heat emanating from the bundles, maximizing beneficial curing and minimizing deleterious heat buildup or mold. Optional dryer or dehumidifier means 5 can be used in conjunction with fan (2), to increase temperature and decrease humidity of Incoming air to facilitate drying of hay. Preferably, temperature sensor means are placed in or between one or more sections of the bundles, to provide a signal to the operator or to a controller means to manually or automatically adjust and balance the inlet and exit gas flows to maintain the bundles within the optimal temperature ranges for curing and subsequent drying.

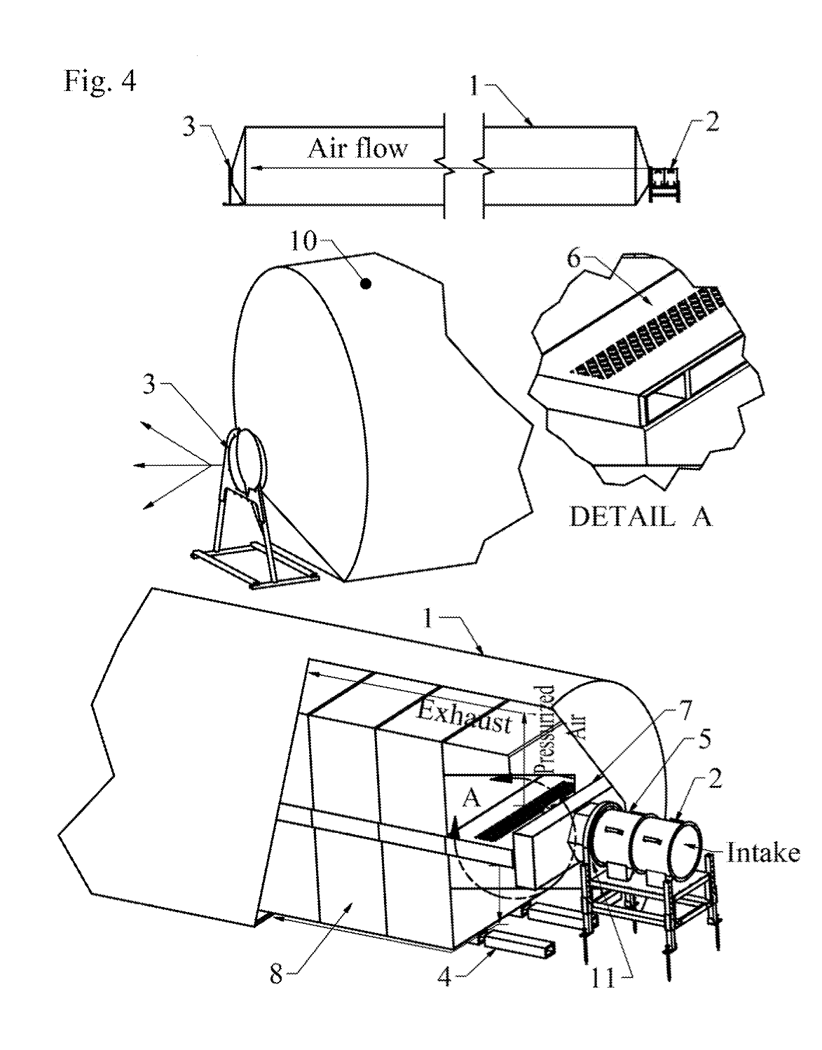

### (See Drawing—FIG. 4)

This preferred embodiment utilizes the same bag, fan and valve as disclosed in the first embodiment. A fan 2 is secured to one end of bag 1. The crop material is loaded into the bag 1. During loading Sleeves 4 are placed underneath bottom bales and Pallet Ducts 6 between first and subsequent levels of bales or bundles. The Pallet Ducts are typically fabricated from plastic, wood, metal or any stiff material, with or without integral ribs for strength. Perforations or openings are in the upper and lower face of the Pallet Ducts, enabling air to be forced through the hay bales or bundles. The Pallet Ducts are interconnected to the fan through a plenum or manifold connection means 7, and to each other, forming an air distribution network. The ends of the ducts adjacent to the end opposite from the fan, at the end with the Exhaust Valve 3, are substantially or completely blocked off, forcing substantially all the air through the pallet ducts and through bales above and below the pallet ducts. The air flows through and exits the bales inflating the bag 1 and transporting moisture from bale out of Exhaust Valve 3. When bag 1 is full of hay an Exhaust Valve 3 is secured to other end of bag 1. Fan 2 is turned on, air flows through the Pallet Ducts 6 forcing the air through the bales of hay. The Exhaust Valve 3 and or the fan 2 are adjusted to control and balance the airflow with the speed and volume of the fan 2 to keep bag 1 inflated while allowing sufficient airflow exhaust to carry out moisture and heat emanating from the bundles. The pallet ducts may be utilized preferably with sleeves under the bottom row of bales but may also be used without the sleeves. The pallet ducts may be used for single, double or multiple rows of bales or bundles. Optional dryer or dehumidifier 5 can be used in conjunction with fan 2, to increase temperature and/or decrease humidity of incoming air to facilitate drying of hay. Pallet ductwork 6 system can be preferably used with sleeves 4 but is not dependant upon sleeves 4.

In another embodiment, the bag, 1 material contains or the exterior coated with a black, dark or other suitable color or material 10, which absorbs solar energy, to enable solar-assisted heating of the air and bales within the bag, accelerating the drying process. In another embodiment, the bag 1 is comprised of or coated with a metallic material, foil or wire mesh, or other conductive material impermeable to microwave energy, and a microwave energy emitter 11, such as those employed in commercial microwave ovens, added in the duct between the fan and the bag contents, generally directed toward the contents, to facilitate drying of the bag contents.

It is understood that minor obvious variations of the following claims remain within the scope, claims and intent of the subject invention. Other variations, modifications and departures lying within the spirit of the invention and scope as defined by the claims will be obvious to those skilled in the art.

We claim:

1. A system and method of storing, drying and preserving fibrous materials comprising:
a. A flexible container of any cross-sectional shape and size, with two or more openings at substantially opposing ends, such container encompassing said fibrous materials.
b. At one end, coupled to the first container opening, a gas injection means,
c. At the second opening, a gas vent means.

2. The system of claim 1, wherein such container is substantially cylindrical in shape.

3. The system of claim 1, wherein rein such container is substantially horizontal in configuration.

4. The system of claim 1, wherein such gas injection means is comprised of a compressed gas source, fan, compressor or other mechanical air injection means.

5. The system of claim 1, wherein the gas vent rate means is variable and of sufficient restrictive backpressure to cause said flexible cylinder to at least partially inflate or expand in cross sectional area, resulting in a decrease in contact area between said container and a portion of such fibrous materials.

6. The system of claim 1, wherein the gas injection means rate is variable.

7. The system of claim 1, wherein the gas injection or gas vent means or both are controlled automatically by a preplanned temperature profile controller means coupled to one or more temperature or humidity sensor means.

8. The system of claim 1, wherein the cylinder is comprised of a flexible water-resistant material.

9. The system of claim 1, wherein such gas is air.

10. The system of claim 1, wherein such as is one or more of a group of organic or inorganic gases.

11. The system of claim 1, wherein such cylinder is substantially comprised of one or more of a group of materials including extruded or cast plastic or coated paper films.

12. The system of claim 1, wherein hollow spacers are placed under one or more layers of baled materials.

13. A system and method of storing, drying and preserving fibrous materials such as hay and forage comprising
a. Placing the fibrous materials or compressed bales of material into an open end of a flexible film cylindrical horizontal bag of substantially round cross-sectional shape and size, with openings at substantially opposing ends, such bag completely containing and encompassing said fibrous materials,
b. At one end, coupled to said container, a gas injection means comprising a fan,
c. At the substantially opposing end, a gas vent means comprising a valve or drawstring opening, partially closing such vent to provide sufficient backpressure to cause said flexible cylinder to inflate or expand in cross sectional area, resulting, in a decrease in contact area between said cylinder sidewalls and a substantial portion of such fibrous materials.
d. Adjusting either the rate of gas injection, the rate of gas exhaust, or both, to maintain the desired temperature of either the fibrous material, or the exhaust gas emanating from the bag, to substantially within an optimal range for the specific fibrous material, to enable microbial fermentation or curing of said fibrous material if desired, and also maintain sufficient rate of drying, and cooling effect to prevent mold growth, self-combustion or heat-induced degradation of the fibrous material.

14. The system and method of claim 13 wherein gas flow through said container is regulated so such temperature range is maintained, in the case of baled straw, hay or similar forage, substantially between ambient and 130 deg. F.

15. The system and method of claim 13, wherein the bales or stacks of bales are separated or supported by one or more hollow spacers.

16. A system and method for storing, curing and drying fibrous plant materials, comprising:
a. a substantially waterproof bag typically fabricated from any group of extruded or cast plastic or water-resistant or coated paper or reinforced films, and of sufficient diameters dependent upon the size of bale or configuration and cross section of bundles to be stored, positioned in a generally horizontal position, typically rolled up to a substantially compact configuration, with total length of a few feet to over one hundred feet extending outward, either totally or partially unrolled. Preferably only unroll and extend sufficient length of bag, to extend over the next bale or group of bundles in a single load.
b. A fan, compressor, gas supply or other mechanical air injection means and support structure secured to one end of bag. The end of the bag not attached to the fan is pulled to begin expanding the length of the unrolled bag.
c. The bundles are loaded into the bag either manually or with any combination of material handling equipment. With each successive load or bale, the bag is preferably pulled and unrolled and length increased to receive the next load of bales or bundles.
d. Exhaust Valve secured to other end of bag. Fan is activated, expanding the bag and creating an airflow on top and around sides of hay bundles. The Exhaust Valve is adjusted to control and balance the airflow with the speed and volume of the fan to keep bag inflated while allowing sufficient airflow exhaust to carry out moisture emanating from the bundles and prevent burn or mildew damage.

17. The system as claimed in claim 16 wherein,
a. Hollow rigid sleeve spacers are placed horizontally between hay bales, with said spacers containing each one or more openings therein directly above and/or below said bales, in general proximity to the center of each bale or stack of hales supported thereby.
b. Said spacers are interconnected to form an air passageway,
c. Gas injection means is connected directly to one end each said spacer passageway,
d. The opposing far end of said air passageway is closed or restricted, forcing the injected gas into and through each bale or stack of bales.

18. The system and method of claim 16 wherein said flexible bag container includes
a. a wire mesh, metal foil or coating or other conductive means in or around such container,
b. A microwave generator and emitter is coupled to said container, directing such microwaves into the fibrous contents to assist in drying.

19. The system and method of claim 16 wherein a heating means such as a dryer is attached to the gas injection means, to increase the temperature of the incoming gas and increase the drying rate of the bag contents.

20. The system and method of claim 16 wherein the bag is comprised of or the exterior coated with a black, dark or other suitable color or material, which absorbs solar energy, to enable solar-assisted heating of the air and fibrous materials within the bag.
